(19) United States
(12) Patent Application Publication
(10) Pub. No.: US 2007/0119845 A1
(43) Pub. Date: May 31, 2007

(54) COOK-TOP AND COOKING SYSTEM HAVING THE SAME

(75) Inventors: Sung Bae SONG, Anyang-si (KR); Seung Jo BAEK, Gwangmyeong-si (KR); Sang Bum SOHN, Seoul (KR); Jong Gwan RYU, Seoul (KR); Byeong Wook PARK, Gwangmyeong-si (KR)

Correspondence Address: GREENBLUM & BERNSTEIN, P.L.C., 1950 ROLAND CLARKE PLACE, RESTON, VA, 20191, US

(73) Assignee: LG ELECTRONICS INC., Seoul (KR)

(21) Appl. No.: 11/424,909

(22) Filed: Jun. 19, 2006

(30) Foreign Application Priority Data
Nov. 25, 2005 (KR) 1020050113481

(51) Int. Cl. H05B 3/68

(52) U.S. Cl. 219/460.1

(57) ABSTRACT

A cooker is disclosed, the cooker comprising: a case having an air inlet and an air outlet; a cooking plate provided on the case; a heating unit formed between the case for heating the cooking plate and the cooking plate; and a cooling unit for cooling the cooking plate by introducing outside air into the air inlet, letting it circulated around the cooking plate, and discharged via the air outlet, such that the cooling time of the cooking plate can be shortened.

### CROSS-REFERENCE TO RELATED APPLICATION

This application claims priority to the application filed with the Korean Industrial Property Office on Nov. 25, 2005, and assigned serial No. 10-2005-0113481, the contents of which are incorporated herein by reference

### BACKGROUND

This invention relates to a cooker, and more particularly to a cooker and a cooking system having the same in which a cooling structure is improved to enable to quickly cool a cooking plate.

The typical electric cooker or electric cook-top (hereinafter referred to as cooker) is known as an environmentally friendly product for developed countries that can always provide a clean and pleasant cooking environment because of being free from hazardous gas, soot, discharge of carbon monoxide and deficiency of oxygen.

The cooker is also recognized as an energy-efficient product because it takes a short time to reach a maximum thermal power by way of using a new material as heat source, and maintains a constant temperature utilizing a temperature sensor.

The cooker configuration includes a case, a cooking plate supported by the case and on which a cooking utensil containing food to be cooked is located, and a heating coil provided at the case for heating the cooking plate.

If an electric power is applied to the cooker, the heating coil generates heat, and the heat thus generated is transmitted to the cooking plate via radiation or convection. Temperature of a cooking region of the cooking plate heated by the heating coil reaches up to 500 degrees Celsius.

Heated condition of the cooking plate can be visually checked by the color of the heating coil in the course of cooking, such that there is hardly a case where a user gets burnt. However, if cooking is done and the power of the heating coil is turned off, the cooking plate is returned to an original color, making it difficult to visually check the temperature of the cooking plate. In other words, if the cooking is finished, there is a high likelihood of a user being burnt due to difficulty in recognizing heated condition of the heating coil.

Particularly, the likelihood of being burnt further increases as it takes a long time of 40-50 minutes for the cooking plate to reach a temperature of approximately 65 degrees Celsius in which a user is not burnt after the heating coil is turned off to naturally cool off.

There is another problem in that if materials such as sugar or condiment fall on the cooking plate during the spontaneous cooling-off period, the materials are solidified on the cooking plate by the high temperature to pollute the cooking plate, causing a user to spend a lot of time and effort to get rid of.

### SUMMARY

The present invention is directed to solve the afore-mentioned problems, and it is an object of the present invention to provide a cooker and a cooking system having the same configured to improve a cooling speed of a cooking plate, thereby enabling to reduce the hazard of a user suffering from burns.

In one general aspect, a cooker comprises: a case having an air inlet and an air outlet; a cooking plate provided on the case; a heating unit formed between the case and the cooking plate for heating the cooking plate; and a cooling unit for cooling the cooking plate by introducing outside air into the air inlet and letting it circulated around the cooking plate and discharged via the air outlet.

According to one embodiment of the present invention, the cooling unit circulates the introduced outside air along a passage formed between the cooking plate and the heating unit.

The cooling unit includes a fan motor unit provided at one side of the case, and at least one circulation guide member provided at the case for guiding the air introduced by the fan motor unit to be evenly circulated underneath the cooking plate.

Preferably, the guide member has a curved surface having a predetermined curvature.

The heating unit may include at least one adiabatic member supported thereunder by the case, an upper end thereof touching the cooking plate, and formed with a passage for passing therethrough the air introduced by the cooling unit, and at least one heat generating body provided at the adiabatic member for being located between the adiabatic member and the cooking plate.

Preferably, an elastic member is formed between the adiabatic member and the case to elastically bring an upper end of the adiabatic member into contact with the cooking plate.

According to another embodiment of the present invention, at least one heating unit is formed at a front end (FD) of the case, and the other heating unit is provided at a rear end (BD) of the case, and wherein the cooling unit comprises: a fan motor unit formed at the front end (FD) of the case; a separating wall formed between the case and the cooking plate for separating the heating unit at the front end (FD) from the heating unit at the rear end (BD) of the case; and at least one circulation guide member provided at a front area of the case divided by the separating wall.

Further, the cooker may include a controller for controlling a driving time of the cooling unit relative to whether an electric power source is applied to the heating unit.

In another general aspect, a cooking system comprises: an oven range provided with a pipe installation recess staged from an upper surface for accommodating a pipe to the rear end (BD) thereof; and a cook-top provided above the oven range, where the cook-top comprises: : a case having an air inlet and an air outlet; a cooking plate provided on the case; a heating unit formed between the case and the cooking plate for heating the cooking plate; and a cooling unit for cooling the cooking plate by introducing outside air into the air inlet and letting it circulated around the cooking plate and discharged via the air outlet.

The cooling unit includes a fan motor unit provided at the case for being accommodated in the pipe accommodation recess, and at least one circulation guide member provided at the case for guiding the air introduced by the fan motor unit to be evenly circulated underneath the cooking plate.

### BRIEF DESCRIPTION OF THE DRAWINGS

FIG. 1 is a perspective view schematically illustrating a cooking system according to one embodiment of the present invention.

FIG. 2 is an exploded perspective view schematically illustrating a cooker of FIG. 1.

FIG. 3 is a cross-sectional view taken along line III-III of FIG. 2.

FIG. 4 is a structural configuration of a cooker of FIG. 2.

FIG. 5 is a plan view explaining a cooling operation of a cooker of FIG. 2.

FIG. 6 is a plan view of a cooker according to another embodiment of the present invention.

FIG. 7 is a cross-sectional view taken along line VII-VII of FIG. 6.

### DETAILED DESCRIPTION

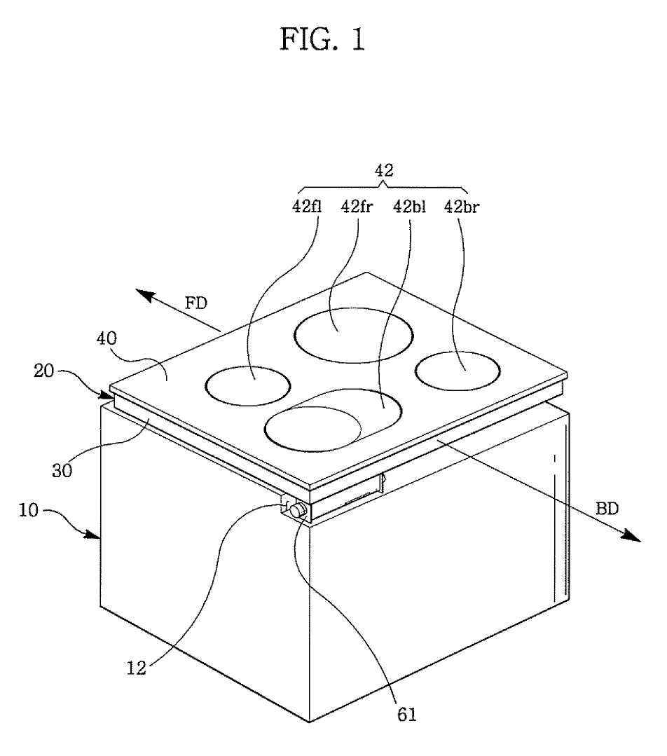

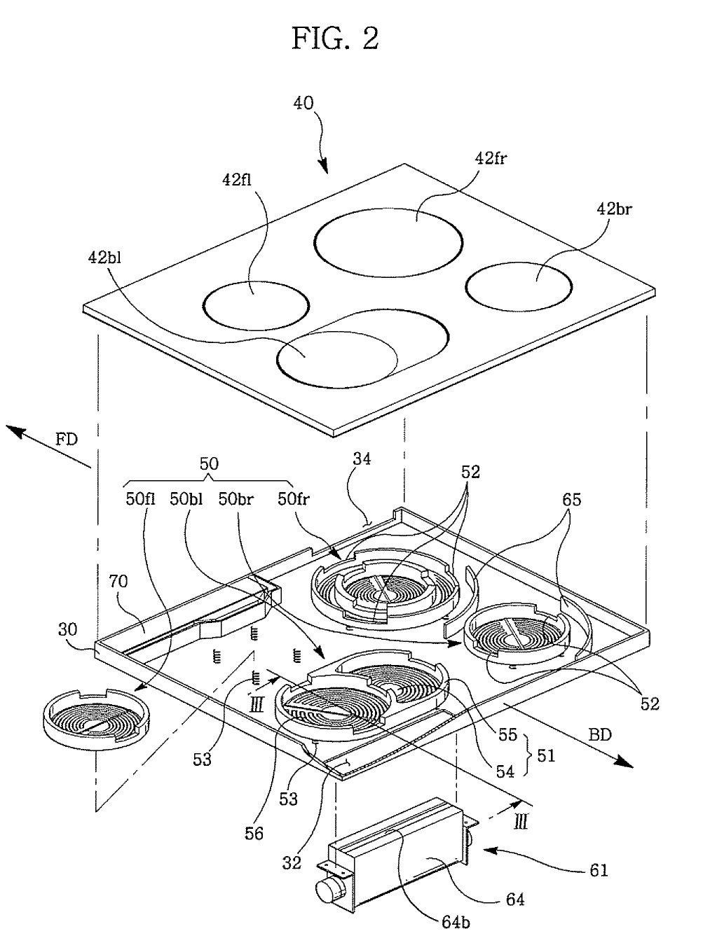

Referring to FIGS. 1 to 4, a cooking system according to one embodiment of the present invention includes an oven range 10 and a cooker 20 provided above the oven range 10.

The oven range 10 includes a cavity (not shown) into which food to be cooked is accommodated, heating means (not shown) for heating the food accommodated in the cavity, and a discharge duct (not shown) and a blowing fan (not shown) for discharging the air heated in the cavity.

The oven range 10 which comes in various types such as a built-in type and a free stand type is a well known art so that detailed description relative to inner structure and operating principle of the oven range 10 will be omitted herein.

The oven range 10 is provided at an upper rear corner thereof with a stair-cased pipe accommodation recess 12 for accommodating a gas pipe in case the oven range 10 or the cooker 20 is fueled by gas. The pipe accommodation recess 12 is typically provided at a rear end (BD) of the cooking system facing a wall surface lest the gas pipe should be exposed outside for cosmetic reason.

The cooker 20 includes a case 30 supported on an upper surface of the oven range 10 at a predetermined distance apart and opened thereon, a cooking plate 40 supported on the case 30 for covering an upper surface of the case 30, a plurality of heating units 50 formed underneath the cooking plate 40, cooling units 61 and 65 for cooling the cooking plate 40, and a controller 70 for controlling the heating units 50 and the cooling units 61 and 65.

An air inlet 32 is provided at a rear end (BD) of the case 30, the inlet 32 being inserted by a fan motor unit 61 for inwardly introducing air circulated by the fan motor unit 61. The case 30 is formed at a front end thereof with an air outlet 34 for discharging the air inwardly introduced into the case 30.

The cooking plate 40 has a plate shape for placing a cooking utensil into which food to be cooked is inserted. The cooking plate 40 is disposed at the case 30 in order to cover an upper surface of the case 30. The cooking plate 40 is disposed thereon with a plurality of cooking areas 42 each corresponding to the heating unit 50. The cooking plate 40 is made of an excellent heat-resistant material such as thermally crystallizable glass of glass-ceramics.

The heating units 50 include front heating units 50fl and 50fr, each arranged left and right of a front end of the cooking plate 40, and rear heating units 50bl and 50br, each arranged left and right of a rear end of the cooking plate 40. The arrangement and the number of heating units may vary or be changed according to specification of the cook-top.

Each of the heating unit 50fl, 50fr, 50bl and 50br is the same in its structure mounted to the case 30, and its structure and configuration contacting the cooking plate 40 such that configuration of one heating unit 50 will be described in the following explanation.

The heating unit 50 includes a adiabatic member 51 elastically supported by a plurality of springs 53 at a floor of the case 30, and a heat generating body 56 provided at the adiabatic member 51.

The adiabatic member 51 is of a hollow cylindrical shape having a floor surface 54 and a brim 55 extended upwards from the floor surface 54. Between the floor surface 54 of the adiabatic member 51 and the case, there is interposed a spring 53 of elastic member 53. The spring 53 serves to push an upper end of the brim 55 to each cooking area 42 of the cooking plate 40 and lets them closely abutted against each other. By this structure, the heat heated by the heat generating body 56 is more effectively transmitted to the cooking plate 40. The brim 55 of the adiabatic member 51 is formed with a plurality of air grooves 52 through which air circulated by the cooling units 61 and 65 can pass.

The heat generating body 56 is provided on the floor surface 54 of the adiabatic member 51 for heating the cooking plate 40. The heat generating body 56 is a heating coil comprised of a composition of chromium (Cr), iron (Fe) and aluminum (Al) which can generate heat by way of electric resistance, but the body 56 can encompass any means which can heat the cooking plate 40 such as a halogen lamp transmitting heat to the cooking plate 40 by way of radiation, a carbon heater employing carbon nano-particles and induction heating coil.

As mentioned above, the heat generating body 56 is disposed being encompassed by the adiabatic member 51, thereby enabling to effectively heat the cooking plate 40.

Particularly, air current circulated by the fan motor unit 61 can pass upwards of an upper end of the heat generating body 56, i.e., between the cooking plate 40 and the adiabatic member 51, by the air grooves 52 formed at the adiabatic member 51, such that the cooking plate 40 can be effectively heated by the heat generating body 56 during cooking operation, and can be also cooled effectively by the air current passing through the air grooves 52.

The cooling units 61 and 65, designed to cool the cooking plate 40 once the cooking operation is finished, include the fan motor unit 61 inserted into the air inlet 32 formed at one side of the rear end (BD) of the case 30, and a plurality of circulation guide members 65 for uniformly circulating the air introduced into an interior of the case 30 by the fan motor unit 61 to the bottom area of the cooking plate 40.

Like the typical fan motor unit, the fan motor unit 61 includes a fan 62, a motor (not shown), and a fan motor case 64 in which the fan 62 and the motor are encased, and is disposed at one side of the rear end (BD) of the case 30 for accommodation into the gas accommodation recess 12. Thus, an exterior of the cooking system can be beautified and can enjoy a compact look because of the fan motor unit 61 being provided at the gas accommodation recess 12.

The fan motor case 64 is frontally provided with an inlet 64a into which an outside air can be introduced with respect to rotation of the fan 62, and is also disposed at a front surface thereof with an outlet 64b for discharging the introduced outside air into the interior of the case 30. Although the fan motor case 64 is exemplified by fixing it to the case 30, the case 64 may be fixed to an upper surface of the oven range 10.

Furthermore, although a transverse current fan is described in the present embodiment, any other fan motor units having a structure capable of discharging outside air into an interior of the case 30 may be applied to the present invention.

The plurality of circulation guide members 65 are provided at the case 30 for uniformly circulating the air current introduced into the case 30 by the fan motor unit 61 into the interior of the cooking plate 40 or the case 30. Preferably, each circulation guide member 65 has a predetermined curvature for a substantial lossless guidance of the air current in the midst of guiding.

The controller 70 is connected to a power source unit 80 for applying an electric power to the heat generating body 56 and the fan motor unit 61. The controller 70 controls the drive of the heat generating body 56 and the fan motor unit 61 in order to control the power source unit 80. Particularly, the controller 70 does not apply the electric power to the fan motor unit 61 during the cooking operation, i.e., while the power is applied to the heat generating body 56. However, once the cooking operation is over, i.e., if the heat generating body 56 is turned off, the controller 70 applies the power to the fan motor unit 61 to drive the fan motor unit 61. Furthermore, the controller 70 counts a driving time of the fan motor unit 61 to turn off the fan motor unit 61.

It should be noted that the fan motor unit 61 may be driven by a separate switch unlike the embodiment of the present invention where the fan motor unit 61 is controlled by the controller 70. Furthermore, unlike the embodiment of the present invention, the controller 70 may compare temperature of the heat generating body 56 or the cooking plate 40 with a pre-set temperature to controllably turn off the fan motor unit 61 if the temperature of the heat generating body 56 or the cooking plate 40 falls under the pre-set temperature.

Still furthermore, the controller 70 may control the power source unit 80 to adjust current or voltage applied to the fan motor unit 61, thereby adjusting the rotating speed of the fan 62.

Now, operation of the cooker and the cooking system according to the embodiment of the present invention, particularly, a cooling operation of the cooking plate 40 will be explained.

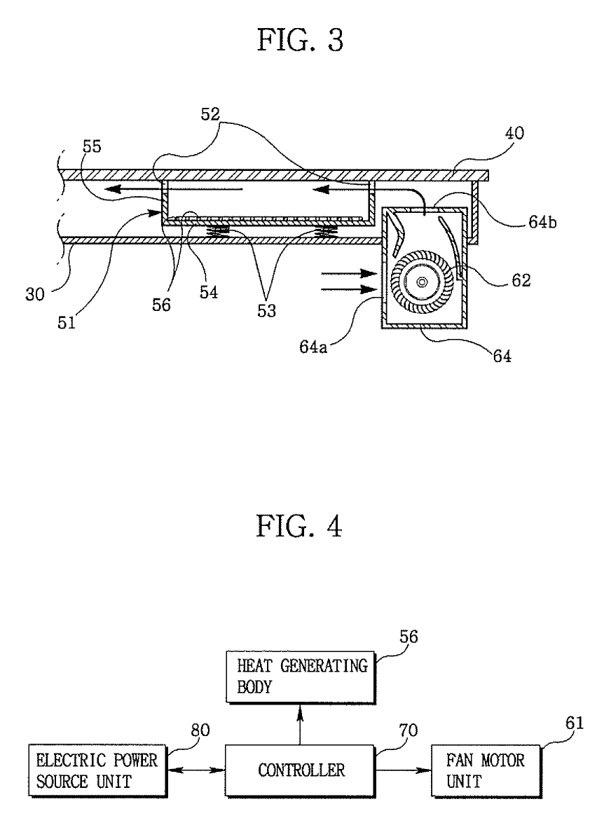

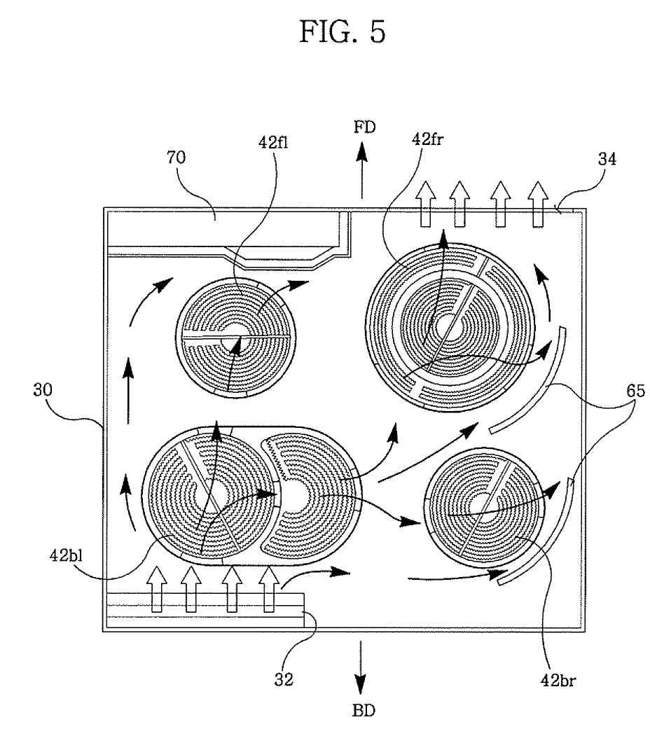

Referring to FIGS. 3 to 5, a user places a cooking utensil on the cooking plate 40 and applies a power to the heat generating body 56. If the cooking operation is done, the user turns off the heat generating body 56. Successively, the controller 70 drives the fan motor unit 61 by applying the power thereto. If the fan motor unit 61 is driven, an outside air is infused into the fan motor case 64 via the inlet 64a. The sucked in air is further infused into the case 30 via the outlet 64b. The air introduced into the case 30 is guided by the circulation guide member 65, passes the plurality of heating units 50 to be discharged to the outside via the air outlet 34 of the case 30.

The air introduced into the case 30 passes the air grooves 52 formed at the adiabatic member 51 of each heating unit 50 to blow out the heat remaining between the adiabatic member 51 and the cooking plate 40 and to circulate along the bottom of the cooking plate 40. As a result, the heat remaining between the adiabatic member 51 and the cooking plate 40 is blown away to enable to improve a cooling speed of the cooking plate 40, and the cooking plate 40 is forcibly cooled according to the circulation of the air circulating underneath the cooking plate 40.

As explained above, when the fan motor unit 61 for cooling the cooking plate 40 is separately installed, the cooling time of the cooking plate 40 was reduced to 16-20 minutes under the same condition according to the embodiment of the present invention, while it took 40-50 minutes to cool the cooking plate 40 to below 65 degrees Celsius according to the prior art. In other words, the cooling time of the cooking plate 40 is reduced approximately by 60% according to the embodiment of the present invention.

With the reduction of the cooling time of the cooking plate 40 thus explained, the likelihood of being burnt can be decreased, and the phenomenon of material such as sugar or condiment fallen on the cooking plate being solidified on the cooking plate and solidified degree thereof can be reduced to thereby enable to expedite the cleaning of the cooking plate 40.

The controller 70 turns off the fan motor unit 61 when the pre-set time lapses away, by counting the driving time of the fan motor unit 61. However, the fan motor unit 61 may be controllably driven with respect to the temperature of the cooking plate 40 or the heat generating body 56, as explained above.

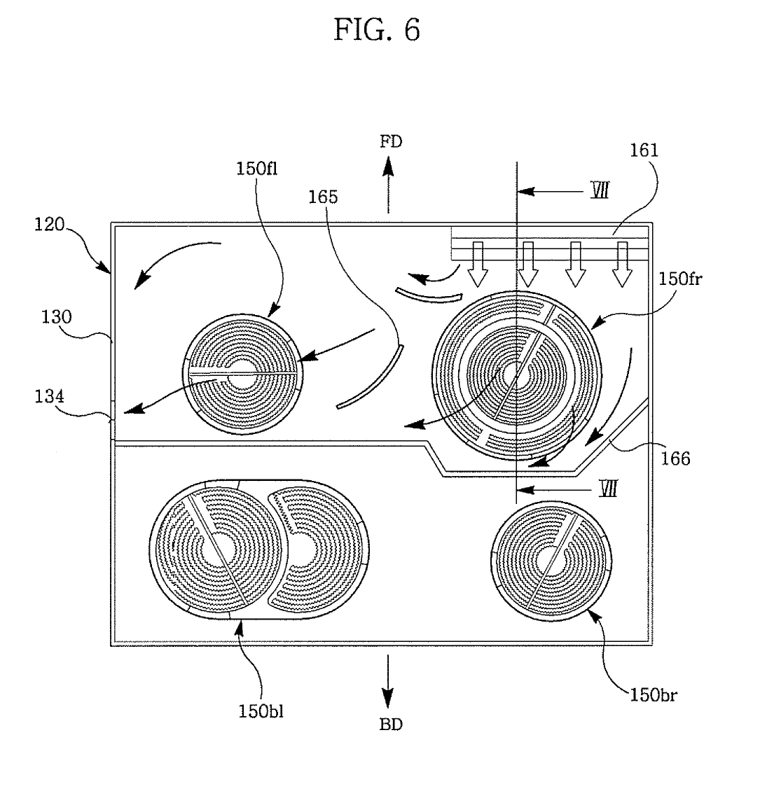

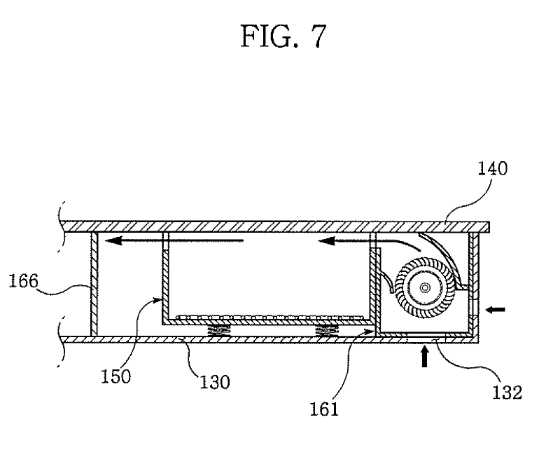

Now, referring to FIGS. 6 and 7, a separating wall 166 is provided at a case 130 for dividing heating units 150fl and 50fr formed at a front end (FD) of the case from heating units 150bl and 150br formed at a rear end (BD) of the case.

An inlet 132 is formed at a front end (FD) of floor surface of the case 130 for inducing inflow of air into the case 130, and an outlet 134 is formed at the other side of the case 130. Furthermore, the case 130 is provided with a circulation guide member 165 for uniformly guiding the air current circulated by a fan motor unit 161 underneath a cooking plate 140.

As aforesaid, if the fan motor unit 161 in the cook-top 120 is driven, air is induced into the inlet 132 and the introduced air is guided by the circulation guide member 165 to circulate underneath the cooking plate 140 and to cool the cooking plate 140. At this time, the air current is not transmitted toward the heating units 150bl and 150br provided at the rear (BD) by the separating wall 166 but circulated only at the heating units 150fl and 150fr at the front (FD) of the case.

In other words, the structure is such that only the cooking areas 42fl and 42fr (see FIG. 1), provided at the front of the cooking plate 140 2 which are frequently used for cooking, are cooled. As a result, the cooling speed of the cooking plate 140 can be further improved to efficiently use the energy because of the cooling structure where frequently-used front cooking areas 42fl and 42fr of the cooking plate 140 are only cooled.

As apparent from the foregoing, there is an advantage in that a cooling plate is forcibly cooled to enable to reduce the time for cooling the cooking plate to a temperature at which a user is prone to suffer burns following the cooking operation. With the reduction of the cooling time of the cooking plate, the hazard of being burnt by the hot cooking plate can be reduced, and solidification of polluting materials onto the cooking plate can be prevented as well.

Particularly, a separating wall is installed at a case to enable to concentratively cool only the front cooking areas of the cooking plate where the cooking operation is frequently conducted, further facilitating reduction of the cooling time and contributing to effective use of energy.

Meanwhile, because a fan motor unit is arranged at a gas accommodation recess, the system is distinguishable for the absence of necessity of a separate space for accommodating the fan motor unit and of being affected by exterior look, thereby contributing to reduction of an overall size.

Although the embodiments of the present invention have been shown and described, the present invention is not limited to the described embodiments. Instead, it would be appreciated by those skilled in the art that various changes may be made to the embodiments without departing from the principles and spirit of the invention, the scope of which is defined by the claims and their equivalents.

What is claimed is:

1. A cooker comprising: a case having an air inlet and an air outlet; a cooking plate provided on the case; a heating unit formed between the case and the cooking plate for heating the cooking plate; and a cooling unit for cooling the cooking plate by introducing outside air into the air inlet and letting it circulated around the cooking plate and discharged via the air outlet.

2. The cooker as defined in claim 1, wherein the cooling unit circulates the introduced outside air along a passage formed between the cooking plate and the heating unit.

3. The cooker as defined in claim 2, wherein the cooling unit comprises: a fan motor unit provided at one side of the case; and at least one circulation guide member provided at the case for guiding the air introduced by the fan motor unit to be evenly circulated underneath the cooking plate.

4. The cooker as defined in claim 2, wherein the heating unit comprises: at least one adiabatic member supported thereunder by the case, an upper end thereof touching the cooking plate, and formed with a passage for passing therethrough the air introduced by the cooling unit; and at least one heat generating body provided at the adiabatic member for being located between the adiabatic member and the cooking plate.

5. The cooker as defined in claim 1, wherein the cooling unit comprises: a fan motor unit provided at one side of the case; and at least one circulation guide member provided at the case for guiding the air introduced by the fan motor unit to be evenly circulated underneath the cooking plate.

6. The cooker as defined in claim 1, wherein the heating unit comprises: at least one adiabatic member supported thereunder by the case, an upper end thereof touching the cooking plate, and formed with a passage for passing therethrough the air introduced by the cooling unit, and at least one heat generating body provided at the adiabatic member for being located between the adiabatic member and the cooking plate.

7. The cooker as defined in claim 6 further comprising an elastic member formed between the adiabatic member and the case to elastically bring an upper end of the adiabatic member into contact with to the cooking plate.

8. The cooker as defined in claim 1, wherein at least one heating unit is formed at a front end (FD) of the case and at least one heating unit is formed at a rear end (BD) of the case, and wherein the cooling unit comprises: a fan motor unit formed at the front end (FD) of the case; a separating wall formed between the case and the cooking plate for separating the heating unit at the front end (FD) from the heating unit at the rear end (BD) of the case; and at least one circulation guide member provided at a front area of the case divided by the separating wall.

9. The cooker as defined in claim 8, wherein the guide member has a curved surface having a predetermined curvature.

10. The cooker as defined in claim 1 further comprising a controller for controlling a driving time of the cooling unit relative to whether an electric power source is applied to the heating unit.

11. A cooking system comprising: an oven range provided with a pipe installation recess staged from an upper surface for accommodating a pipe to the rear end (BD) thereof; and a cooker provided above the oven range, and wherein the cooker comprises:: a case having an air inlet and an air outlet; a cooking plate provided on the case; a heating unit formed between the case and the cooking plate for heating the cooking plate;
and a cooling unit for cooling the cooking plate by introducing outside air into the air inlet and letting it circulated around the cooking plate and discharged via the air outlet.

12. The system as defined in claim 11, wherein the cooling unit circulates the introduced outside air along a passage formed between the cooking plate and the heating unit.

13. The system as defined in claim 12, wherein the cooling unit comprises: a fan motor unit provided at the case for being accommodated in the gas accommodation recess; and at least one circulation guide member provided at the case for guiding the air introduced by the fan motor unit to be evenly circulated underneath the cooking plate.

14. The system as defined in claim 12, wherein the heating member comprises: at least one adiabatic member supported thereunder by the case, an upper end thereof touching the cooking plate, and formed with a passage for passing therethrough the air introduced by the cooling unit; and at least one heat generating body provided at the adiabatic member for being located between the adiabatic member and the cooking plate.

15. The system as defined in claim 11, wherein the cooling unit comprises: a fan motor unit provided at the case for being accommodated in the pipe accommodation recess; and at least one circulation guide member provided at the case for guiding the air introduced by the fan motor unit to be evenly circulated underneath the cooking plate.

16. The system as defined in claim 15, wherein the guide member has a curved surface having a predetermined curvature.

17. The system as defined in claim 11, wherein the heating unit comprises: at least one adiabatic member supported thereunder by the case, an upper end thereof touching the cooking plate, and formed with a passage for passing therethrough the air introduced by the cooling unit; and at least one heat generating body provided at the adiabatic member for being located between the adiabatic member and the cooking plate.

18. The system as defined in 17 further comprising an elastic member formed between the adiabatic member and the case to elastically bring an upper end of the adiabatic member into contact with the cooking plate.

19. The system as defined in claim 11, wherein at least one heating unit is formed at a front end (FD) of the case, and at least one heating unit is formed at a rear end (BD) of the case, and wherein the cooling unit comprises: a fan motor unit formed at the front end (FD) of the case; a separating wall formed between the case and the cooking plate for separating the heating unit at the front end (FD) from the heating unit at the rear end (BD) of the case; and at least one circulation guide member provided at a front area of the case divided by the separating wall.

20. The system as defined in claim 11 further comprising a controller for controlling a driving time of the cooling unit relative to whether an electric power source is applied to the heating unit.
